(19) United States
(12) Patent Application Publication
(10) Pub. No.: US 2023/0169397 A1
(43) Pub. Date: Jun. 1, 2023

(54) METHODS AND APPARATUS FOR ATTESTATION OF AN ARTIFICIAL INTELLIGENCE MODEL

(71) Applicant: Intel Corporation, Santa Clara, CA (US)

(72) Inventors: Ned M. Smith, Beaverton, OR (US); Francesc Guim Bernat, Barcelona (ES); Rita Chattopadhyay, Chandler, AZ (US); Sunil Cheruvu, Tempe, AZ (US)

(21) Appl. No.: 17/919,510

(22) PCT Filed: May 17, 2021
(86) PCT No.: PCT/US2021/032822

§ 371 Date: Oct. 17, 2022

Related U.S. Application Data
(60) Provisional application No. 63/026,711, filed on May 18, 2020.

(51) Int. Cl. G06N 20/00

(52) U.S. Cl. CPC G06N 20/00

(57) ABSTRACT

Methods, apparatus, systems and articles of manufacture to train a model using attestation data are disclosed. An example apparatus includes a model trainer to train a machine learning model using a golden training data set received from a server to generate golden training results; and an attestation result generator to: compare the shared model training results to the golden training results; and determine if attestation of the shared model training results passes based on the comparison of the shared model training results and the golden training results.

### RELATED APPLICATIONS

U.S. Provisional Patent Application Ser. No. 63/026,711, filed May 18, 2020, is hereby incorporated herein by reference in its entirety. Priority to U.S. Patent Application Ser. No. 63/026,711 is hereby claimed.

### FIELD OF THE DISCLOSURE

This disclosure relates generally to artificial intelligence, and, more particularly, to methods and apparatus for attestation of an artificial intelligence model.

### BACKGROUND

Edge computing, at a general level, refers to the transition of compute and storage resources closer to endpoint devices (e.g., consumer computing devices, user equipment, etc.) in order to optimize total cost of ownership, reduce application latency, improve service capabilities, and improve compliance with data privacy or security requirements. Edge computing may, in some scenarios, provide a cloud-like distributed service that offers orchestration and management for applications among many types of storage and compute resources. As a result, some implementations of edge computing have been referred to as the “edge cloud” or the “fog,” as powerful computing resources previously available only in large remote data centers are moved closer to endpoints and made available for use by consumers at the “edge” of the network.

### BRIEF DESCRIPTION OF THE DRAWINGS

FIG. 1 illustrates an overview of an edge cloud configuration for edge computing.

FIG. 2 illustrates operational layers among endpoints, an edge cloud, and cloud computing environments.

FIG. 3 illustrates an example approach for networking and services in an edge computing system.

FIG. 4 is a block diagram of an example edge computing system for providing edge services and applications to multi-stakeholder entities.

FIG. 5 illustrates an example scenario in which an attacker can improperly and maliciously influence a neural network (e.g., a convolutional neural network (CNN) model).

FIG. 6 illustrates an example in which the attestation disclosed herein is deployed in a multi-tiered edge architecture.

FIG. 7 is a block diagram of an example implementation of an analyzer constructed in accordance with the teachings of this disclosure.

FIGS. 8-9 are flowcharts representative of machine readable instructions which may be executed to implement the example apparatus of FIG. 4.

FIG. 10 provides an overview of example components for compute deployed at a compute node in an edge computing system.

FIG. 11 provides a further overview of example components within a computing device in an edge computing system.

FIG. 12 is a block diagram of an example software distribution platform to distribute software (e.g., software corresponding to the example computer readable instructions of FIGS. 8-9) to client devices such as consumers (e.g., for license, sale and/or use), retailers (e.g., for sale, re-sale, license, and/or sub-license), and/or original equipment manufacturers (OEMs) (e.g., for inclusion in products to be distributed to, for example, retailers and/or to direct buy customers).

The figures are not to scale. Instead, the thickness of the layers or regions may be enlarged in the drawings. In general, the same reference numbers will be used throughout the drawing(s) and accompanying written description to refer to the same or like parts. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc. are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, “approximately” and “about” refer to dimensions that may not be exact due to manufacturing tolerances and/or other real world imperfections. As used herein “substantially real time” refers to occurrence in a near instantaneous manner recognizing there may be real world delays for computing time, transmission, etc. Thus, unless otherwise specified, “substantially real time” refers to real time +/−1 second.

### DETAILED DESCRIPTION

In some examples, edge devices in an edge computing infrastructure include one or more sensors that enable reporting of data to another device (e.g., an aggregator) for processing. The processing, in some examples, involves application of an artificial intelligence (AI) and/or a machine learning (ML) model to generate an output. Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

Many different types of machine learning models and/or machine learning architectures exist including, for example, Random Forest models, Support Vector Machines (SVMs), Neural Networks, etc. Different machine learning models/architectures may be more well-suited to performing particular tasks. For example, some machine learning models/architectures may be more suited for classification tasks, as opposed to output prediction, language processing, etc. In examples disclosed herein, a machine learning model for classification of inputs is used. However, any other types of machine learning models could additionally or alternatively be used.

In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.) Alternatively, unsupervised training (e.g., used in deep learning, a subset of machine learning, etc.) involves inferring patterns from inputs to select parameters for the ML/AI model (e.g., without the benefit of expected (e.g., labeled) outputs).

Artificial Intelligence (AI) (e.g. neuromorphic computing, machine learning, deep learning) is increasingly relied upon for managing and maintaining critical infrastructure and factory automation/operation, performing edge services optimization, etc. AI relies on a training period wherein a model is developed that determines how the AI engine will behave when exposed to live data and/or operational inputs.

Trained models can become stale over time and re-training is often necessary. When a new model is re-trained the old model is typically discarded. However, re-training may pose a security and/or safety risk if an attacker is able to compromise the system during training.

For example, decentralized network deployments such as an Edge ecosystem do not benefit from a centralized trusted repository of trained models. Instead, peer stakeholders in the Edge ecosystem establish trust in a peer stakeholder and its network. Often this process involves trusting the AI-based control and analytics behaviors of the trained models of a peer. Methods and apparatus as disclosed herein facilitate attestation of a trained model of a peer device (e.g., an edge device). In some examples disclosed herein, attestation is performed by measuring (introspecting) AI models and evaluating the measurements based on a history of previously attested models.

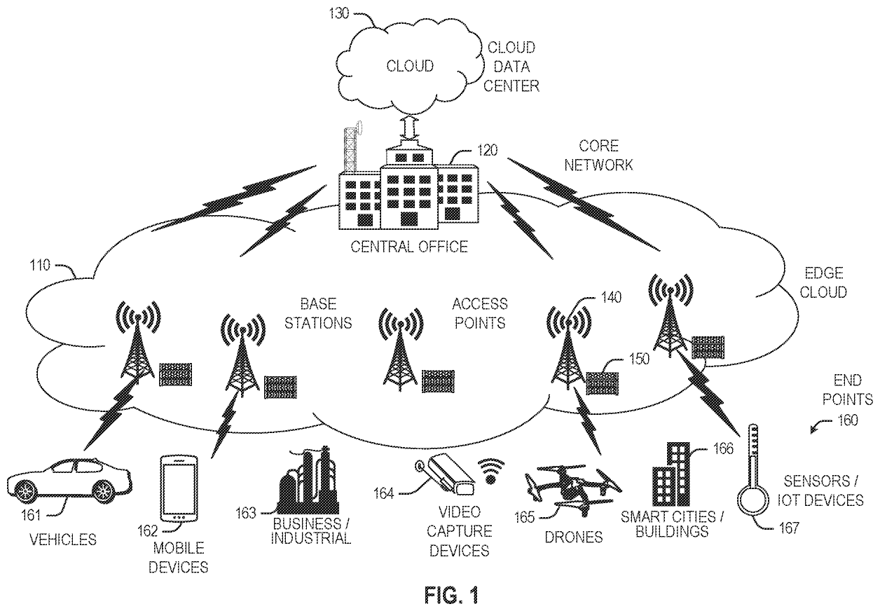

FIG. 1 is a block diagram 100 showing an overview of a configuration for edge computing, which includes a layer of processing referred to in many of the following examples as an “edge cloud”. As shown, the edge cloud 110 is co-located at an edge location, such as an access point or base station 140, a local processing hub 150, or a central office 120, and thus may include multiple entities, devices, and equipment instances. The edge cloud 110 is located much closer to the endpoint (consumer and producer) data sources 160 (e.g., autonomous vehicles 161, user equipment 162, business and industrial equipment 163, video capture devices 164, drones 165, smart cities and building devices 166, sensors and IoT devices 167, etc.) than the cloud data center 130. Compute, memory, and storage resources which are offered at the edges in the edge cloud 110 are critical to providing ultra-low latency response times for services and functions used by the endpoint data sources 160 as well as reduce network backhaul traffic from the edge cloud 110 toward cloud data center 130 thus improving energy consumption and overall network usages among other benefits.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the amount of resources needed for network services, through the distribution of more resources which are located closer both geographically and in network access time. In this manner, edge computing attempts to bring the compute resources to the workload data where appropriate, or, bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, typically through the use of a compute platform (e.g., x86 or ARM compute hardware architecture) implemented at base stations, gateways, network routers, or other devices which are much closer to endpoint devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of service and consumer functions for connected devices. Within edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

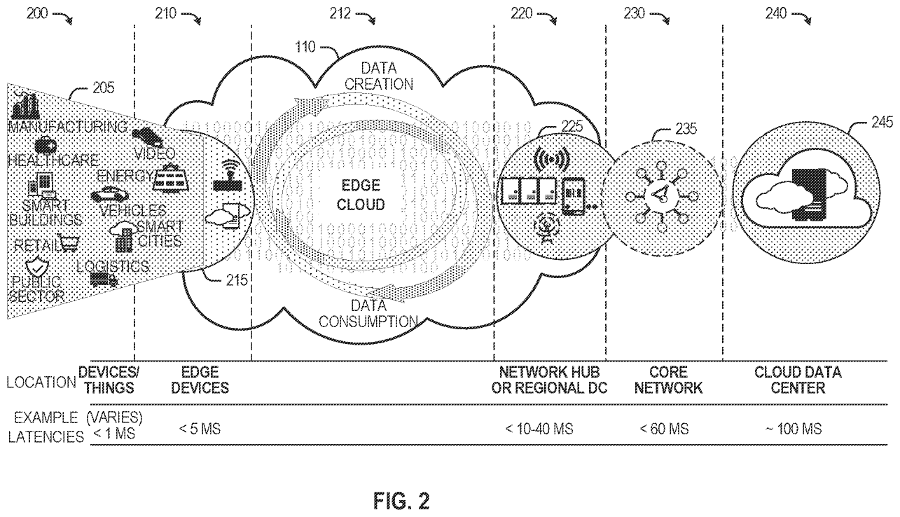

FIG. 2 illustrates operational layers among endpoints, an edge cloud, and cloud computing environments. Specifically, FIG. 2 depicts examples of computational use cases 205, utilizing the edge cloud 110 among multiple illustrative layers of network computing. The layers begin at an endpoint (devices and things) layer 200, which accesses the edge cloud 110 to conduct data creation, analysis, and data consumption activities. The edge cloud 110 may span multiple network layers, such as an edge devices layer 210 having gateways, on-premises servers, or network equipment (nodes 215) located in physically proximate edge systems; a network access layer 220, encompassing base stations, radio processing units, network hubs, regional data centers (DC), or local network equipment (equipment 225); and any equipment, devices, or nodes located therebetween (in layer 212, not illustrated in detail). The network communications within the edge cloud 110 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 200, under 5 ms at the edge devices layer 210, to even between 10 to 40 ms when communicating with nodes at the network access layer 220. Beyond the edge cloud 110 are core network 230 and cloud data center 240 layers, each with increasing latency (e.g., between 50-60 ms at the core network layer 230, to 100 or more ms at the cloud data center layer). As a result, operations at a core network data center 235 or a cloud data center 245, with latencies of at least 50 to 100 ms or more, will not be able to accomplish many time-critical functions of the use cases 205. Each of these latency values are provided for purposes of illustration and contrast; it will be understood that the use of other access network mediums and technologies may further reduce the latencies. In some examples, respective portions of the network may be categorized as “close edge”, “local edge”, “near edge”, “middle edge”, or “far edge” layers, relative to a network source and destination. For instance, from the perspective of the core network data center 235 or a cloud data center 245, a central office or content data network may be considered as being located within a “near edge” layer (“near” to the cloud, having high latency values when communicating with the devices and endpoints of the use cases 205), whereas an access point, base station, on-premise server, or network gateway may be considered as located within a “far edge” layer (“far” from the cloud, having low latency values when communicating with the devices and endpoints of the use cases 205). It will be understood that other categorizations of a particular network layer as constituting a “close”, “local”, “near”, “middle”, or “far” edge may be based on latency, distance, number of network hops, or other measurable characteristics, as measured from a source in any of the network layers 200-240.

The various use cases 205 may access resources under usage pressure from incoming streams, due to multiple services utilizing the edge cloud. To achieve results with low latency, the services executed within the edge cloud 110 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to SLA, the system as a whole (components in the transaction) may provide the ability to (1) understand the impact of the SLA violation, (2) augment other components in the system to resume overall transaction SLA, and (3) implement steps to remediate.

Thus, with these variations and service features in mind, edge computing within the edge cloud 110 may provide the ability to serve and respond to multiple applications of the use cases 205 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), standard processes, etc.), which cannot leverage conventional cloud computing due to latency or other limitations.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because edge locations may be unmanned and may even need permissioned access (e.g., when housed in a third-party location). Such issues are magnified in the edge cloud 110 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 110 (network layers 200-240), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 110.

As such, the edge cloud 110 is formed from network components and functional features operated by and within edge gateway nodes, edge aggregation nodes, or other edge compute nodes among network layers 210-230. The edge cloud 110 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 110 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

The network components of the edge cloud 110 may be servers, multi-tenant servers, appliance computing devices, and/or any other type of computing devices. For example, the edge cloud 110 may include an appliance computing device that is a self-contained electronic device including a housing, a chassis, a case or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., EMI, vibration, extreme temperatures), and/or enable submergibility. Example housings may include power circuitry to provide power for stationary and/or portable implementations, such as AC power inputs, DC power inputs, AC/DC or DC/AC converter(s), power regulators, transformers, charging circuitry, batteries, wired inputs and/or wireless power inputs. Example housings and/or surfaces thereof may include or connect to mounting hardware to enable attachment to structures such as buildings, telecommunication structures (e.g., poles, antenna structures, etc.) and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, etc.) and/or articulating hardware (e.g., robot arms, pivotable appendages, etc.). In some circumstances, the sensors may include any type of input devices such as user interface hardware (e.g., buttons, switches, dials, sliders, etc.). In some circumstances, example housings include output devices contained in, carried by, embedded therein and/or attached thereto. Output devices may include displays, touchscreens, lights, LEDs, speakers, I/O ports (e.g., USB), etc. In some circumstances, edge devices are devices presented in the network for a specific purpose (e.g., a traffic light), but may have processing and/or other capacities that may be utilized for other purposes. Such edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIG. D1B. The edge cloud 110 may also include one or more servers and/or one or more multi-tenant servers. Such a server may include an operating system and implement a virtual computing environment. A virtual computing environment may include a hypervisor managing (e.g., spawning, deploying, destroying, etc.) one or more virtual machines, one or more containers, etc. Such virtual computing environments provide an execution environment in which one or more applications and/or other software, code or scripts may execute while being isolated from one or more other applications, software, code or scripts.

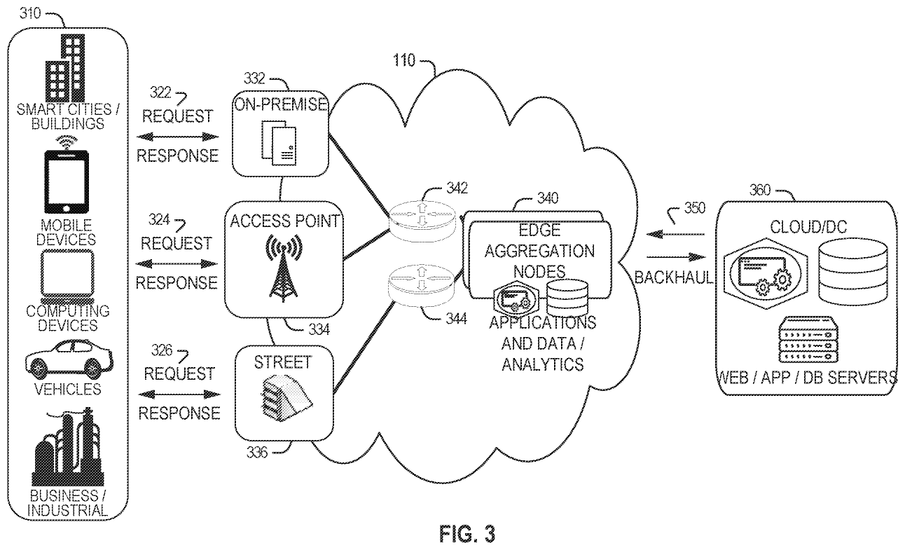

In FIG. 3, various client endpoints 310 (in the form of mobile devices, computers, autonomous vehicles, business computing equipment, industrial processing equipment) exchange requests and responses that are specific to the type of endpoint network aggregation. For instance, client endpoints 310 may obtain network access via a wired broadband network, by exchanging requests and responses 322 through an on-premise network system 332. Some client endpoints 310, such as mobile computing devices, may obtain network access via a wireless broadband network, by exchanging requests and responses 324 through an access point (e.g., cellular network tower) 334. Some client endpoints 310, such as autonomous vehicles may obtain network access for requests and responses 326 via a wireless vehicular network through a street-located network system 336. However, regardless of the type of network access, the TSP may deploy aggregation points 342, 344 within the edge cloud 110 to aggregate traffic and requests. Thus, within the edge cloud 110, the TSP may deploy various compute and storage resources, such as at edge aggregation nodes 340, to provide requested content. The edge aggregation nodes 340 and other systems of the edge cloud 110 are connected to a cloud or data center 360, which uses a backhaul network 350 to fulfill higher-latency requests from a cloud/data center for websites, applications, database servers, etc. Additional or consolidated instances of the edge aggregation nodes 340 and the aggregation points 342, 344, including those deployed on a single server framework, may also be present within the edge cloud 110 or other areas of the TSP infrastructure.

Edge computing, at a general level, refers to the transition of compute and storage resources closer to endpoint devices (e.g., consumer computing devices, user equipment, etc.) in order to optimize total cost of ownership, reduce application latency, improve service capabilities, and improve compliance with data privacy or security requirements. Edge computing may, in some scenarios, provide a cloud-like distributed service that offers orchestration and management for applications among many types of storage and compute resources. As a result, some implementations of edge computing have been referred to as the “edge cloud” or the “fog,” as powerful computing resources previously available only in large remote data centers are moved closer to endpoints and made available for use by consumers at the “edge” of the network.

In some examples, edge devices in an edge computing infrastructure include one or more sensors that enable reporting of data to another device (e.g., an aggregator) for processing. The processing, in some examples, involves application of an artificial intelligence (AI) and/or a machine learning (ML) model to generate an output. Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

Many different types of machine learning models and/or machine learning architectures exist including, for example, Random Forest models, Support Vector Machines (SVMs), Neural Networks, Convolutional Neural Network (CNN), etc. Different machine learning models/architectures may be more well-suited to performing particular tasks. For example, some machine learning models/architectures may be more suited for classification tasks, as opposed to output prediction, language processing, etc. In examples disclosed herein, a machine learning model for classification of inputs is used. However, any other types of machine learning models could additionally or alternatively be used.

In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.) Alternatively, unsupervised training (e.g., used in deep learning, a subset of machine learning, etc.) involves inferring patterns from inputs to select parameters for the ML/AI model (e.g., without the benefit of expected (e.g., labeled) outputs).

Artificial Intelligence (AI) (e.g., neuromorphic computing, machine learning, deep learning) is increasingly relied upon for managing and maintaining critical infrastructure and factory automation/operation, performing edge services optimization, etc. AI relies on a training period wherein a model is developed that determines how the AI engine will behave when exposed to live data and/or operational inputs.

Trained models can become stale over time and re-training is often necessary. When a new model is re-trained the old model is typically discarded. However, re-training may pose a security and/or safety risk if an attacker is able to compromise the system during training.

For example, decentralized network deployments such as an Edge ecosystem do not benefit from a centralized trusted repository of trained models. Instead, peer stakeholders in the Edge ecosystem establish trust in a peer stakeholder and its network. Often this process involves trusting the AI-based control and analytics behaviors of the trained models of a peer. Methods and apparatus as disclosed herein facilitate attestation of a trained model of a peer device (e.g., an edge device). In some examples disclosed herein, attestation is performed by measuring (introspecting) AI models and evaluating the measurements based on a history of previously attested models.

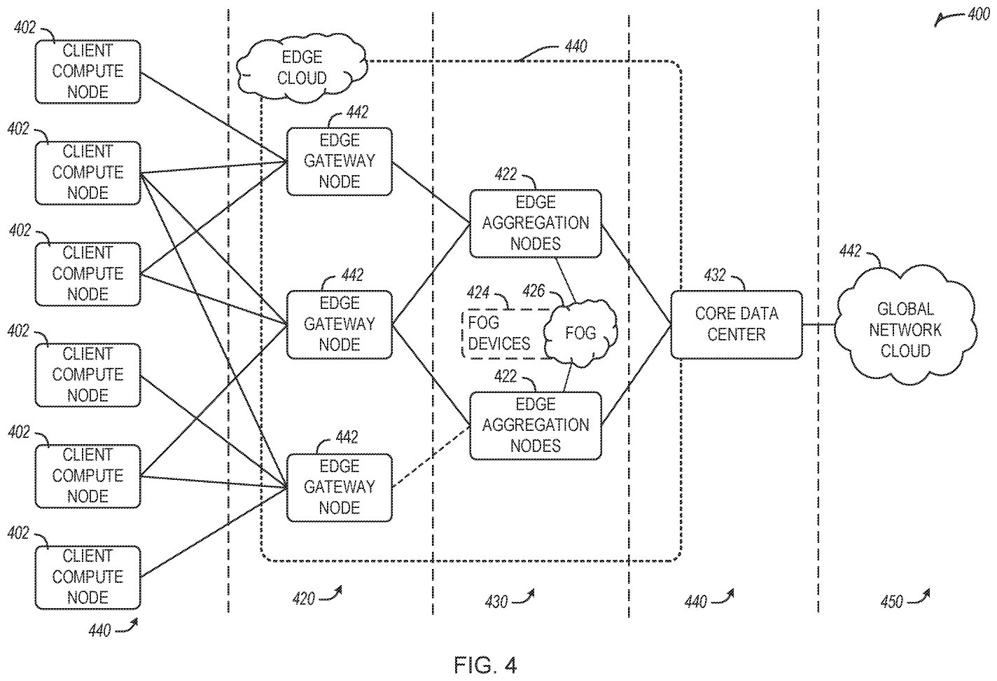

FIG. 4 is a block diagram of an example edge computing system 400 for providing edge services and applications to multi-stakeholder entities, as distributed among one or more client compute nodes 402, one or more edge gateway nodes 412, one or more edge aggregation nodes 422, one or more core data centers 432, and a global network cloud 442, as distributed across layers of the network. The implementation of the edge computing system 400 may be provided at or on behalf of a telecommunication service provider (“telco”, or “TSP”), internet-of-things service provider, cloud service provider (CSP), enterprise entity, or any other number of entities. Various implementations and configurations of the system 400 may be provided dynamically, such as when orchestrated to meet service objectives. The system 400 may implement a Multi-access Edge Computing (MEC) system.

Individual nodes or devices of the edge computing system 400 are located at a particular layer corresponding to layers 410, 420, 430, 440, 450. For example, the client compute nodes 402 are located at an endpoint layer 410, while the edge gateway nodes 412 are located at an edge devices layer 420 (local level) of the edge computing system 400. Additionally, the edge aggregation nodes 422 (and/or fog devices 424, if arranged or operated with or among a fog networking configuration 426) are located at a network access layer 430 (an intermediate level). Fog computing (or “fogging”) generally refers to extensions of cloud computing to the edge of an enterprise's network or to the ability to manage transactions across the cloud/edge landscape, typically in a coordinated distributed or multi-node network. Some forms of fog computing provide the deployment of compute, storage, and networking services between end devices and cloud computing data centers, on behalf of the cloud computing locations. Some forms of fog computing also provide the ability to manage the workload/workflow level services, in terms of the overall transaction, by pushing certain workloads to the edge or to the cloud based on the ability to fulfill the overall service level agreement.

Fog computing in many scenarios provide a decentralized architecture and serves as an extension to cloud computing by collaborating with one or more edge node devices, providing the subsequent amount of localized control, configuration and management, and much more for end devices. Furthermore, Fog computing provides the ability for edge resources to identify similar resources and collaborate in order to create an edge-local cloud which can be used solely or in conjunction with cloud computing in order to complete computing, storage or connectivity related services. Fog computing may also allow the cloud-based services to expand their reach to the edge of a network of devices to offer local and quicker accessibility to edge devices. Thus, some forms of fog computing provide operations that are consistent with edge computing as discussed herein; the edge computing aspects discussed herein are also applicable to fog networks, fogging, and fog configurations. Further, aspects of the edge computing systems discussed herein may be configured as a fog, or aspects of a fog may be integrated into an edge computing architecture.

The core data center 432 is located at a core network layer 440 (a regional or geographically-central level), while the global network cloud 442 is located at a cloud data center layer 450 (a national or world-wide layer).

The use of “core” is provided as a term for a centralized network location— deeper in the network—which is accessible by multiple edge nodes or components; however, a “core” does not necessarily designate the “center” or the deepest location of the network. Accordingly, the core data center 432 may be located within, at, or near the edge cloud 410. Although an illustrative number of client compute nodes 402, edge gateway nodes 412, edge aggregation nodes 422, edge core data centers 432, global network clouds 442 are shown in FIG. 4, it should be appreciated that the edge computing system 400 may include additional devices or systems at each layer. Devices at any layer can be configured as peer nodes to each other and, accordingly, act in a collaborative manner to meet service objectives. Additionally, as shown in FIG. 4, the number of components of respective layers 410, 420, 430, 440, 450 generally increases at each lower level (e.g., when moving closer to endpoints). As such, one edge gateway node 412 may service multiple client compute nodes 402, and one edge aggregation node 422 may service multiple edge gateway nodes 412.

Consistent with the examples provided herein, a client compute node 402 may be embodied as any type of endpoint component, device, appliance, or other thing capable of communicating as a producer or consumer of data. Further, the label “node” or “device” as used in the edge computing system 400 does not necessarily mean that such node or device operates in a client or slave role; rather, any of the nodes or devices in the edge computing system 400 refer to individual entities, nodes, or subsystems which include discrete or connected hardware or software configurations to facilitate or use the edge cloud 410.

As such, the edge cloud 410 is formed from network components and functional features operated by and within the edge gateway nodes 412 and the edge aggregation nodes 422 of layers 410, 420, respectively. The edge cloud 410 may be embodied as any type of network that provides edge computing and/or storage resources which are proximately located to radio access network (RAN) capable endpoint devices (e.g., mobile computing devices, IoT devices, smart devices, etc.), which are shown in FIG. 4 as the client compute nodes 402. In other words, the edge cloud 410 may be envisioned as an “edge” which connects the endpoint devices and traditional network access points that serves as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

In some examples, the edge cloud 410 may form a portion of or otherwise provide an ingress point into or across a fog networking configuration 426 (e.g., a network of fog devices 424, not shown in detail), which may be embodied as a system-level horizontal and distributed architecture that distributes resources and services to perform a specific function. For instance, a coordinated and distributed network of fog devices 424 may perform computing, storage, control, or networking aspects in the context of an IoT system arrangement. Other networked, aggregated, and distributed functions may exist in the edge cloud 410 between the core data center 432 and the client endpoints (e.g., client compute nodes 402). Some of these are discussed in the following sections in the context of network functions or service virtualization, including the use of virtual edges and virtual services which are orchestrated for multiple stakeholders.

As discussed in more detail below, the edge gateway nodes 412 and the edge aggregation nodes 422 cooperate to provide various edge services and security to the client compute nodes 402. Furthermore, because a client compute node 402 may be stationary or mobile, a respective edge gateway node 412 may cooperate with other edge gateway devices to propagate presently provided edge services, relevant service data, and security as the corresponding client compute node 402 moves about a region. To do so, the edge gateway nodes 412 and/or edge aggregation nodes 422 may support multiple tenancy and multiple stakeholder configurations, in which services from (or hosted for) multiple service providers, owners, and multiple consumers may be supported and coordinated across a single or multiple compute devices.

A variety of security approaches may be utilized within the architecture of the edge cloud 410. In a multi-stakeholder environment, there can be multiple loadable security modules (LSMs) used to provision policies that enforce the stakeholders interests. Enforcement point environments could support multiple LSMs that apply the combination of loaded LSM policies (e.g., where the most constrained effective policy is applied, such as where if any of A, B or C stakeholders restricts access then access is restricted). Within the edge cloud 410, each edge entity can provision LSMs that enforce the Edge entity interests. The Cloud entity can provision LSMs that enforce the cloud entity interests. Likewise, the various Fog and IoT network entities can provision LSMs that enforce the Fog entity's interests.

In these examples, services may be considered from the perspective of a transaction, performed against a set of contracts or ingredients, whether considered at an ingredient level or a human-perceivable level. Thus, a user who has a service agreement with a service provider, expects the service to be delivered under terms of the SLA. Although not discussed in detail, the use of the edge computing techniques discussed herein may play roles during the negotiation of the agreement and the measurement of the fulfillment of the agreement (to identify what elements are required by the system to conduct a service, how the system responds to service conditions and changes, and the like).

A “service” is a broad term often applied to various contexts, but in general it refers to a relationship between two entities where one entity offers and performs work for the benefit of another. However, the services delivered from one entity to another must be performed with certain guidelines, which ensure trust between the entities and manage the transaction according to the contract terms and conditions set forth at the beginning, during and end of the service.

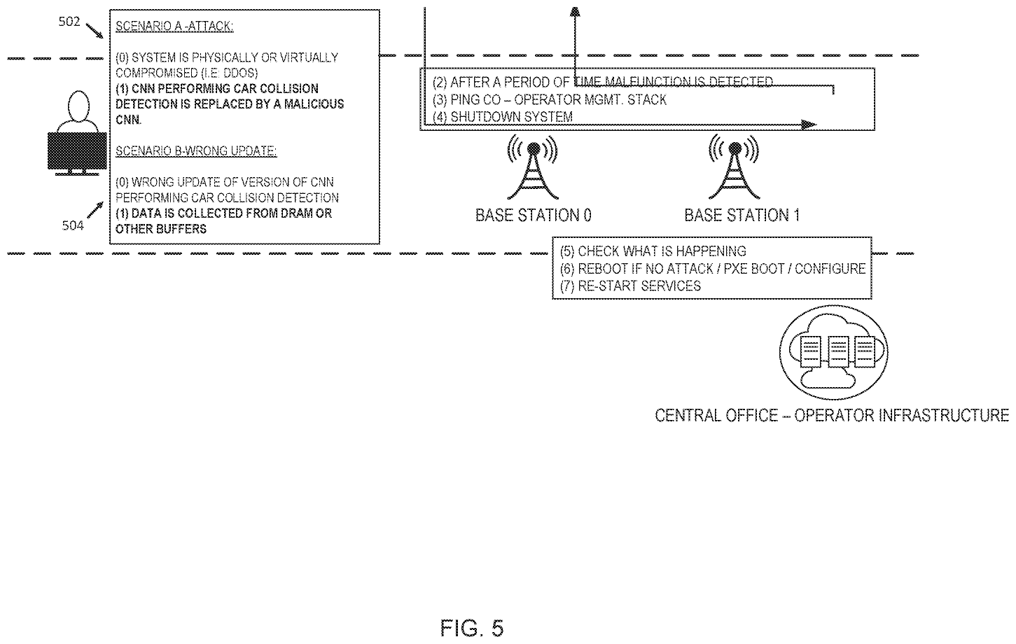

FIG. 5 illustrates a diagram of an example scenario in which an attacker can improperly and maliciously influence a neural network (e.g., a convolutional neural network (CNN) model). Two example attacker scenarios are illustrated. According to Scenario A 502, the attacker compromises a device either physically or virtually (e.g., an edge device in an edge computing system such as the edge computing system 400 of FIG. 4) and replaces a CNN with a malicious CNN. According to Scenario B 504, a CNN is incorrectly updated and data is collected from persisted DRAM, SRAM, battery-backed SRAM, MRAM, FLASH or other persisted memory or buffers writing to persisted memory. According to the examples, if the CNN performing the action can be compromised (or even updated with the wrong version or type of CNN) it may take some time to detect and fix the problem.

One of the limitations of current attestation solutions (such as a trusted platform module (TPM) using a hardware-based cloud security solution such as Intel® Security Libraries (IsecL)) is that they can validate elements such as firmware, OS, or applications but not metadata and device specific settings that may be used to configure the applications, libraries, firmware and system software. In this case, if the service uses a CNN described in a metadata file (such as based on ONIX format), the system and end device cannot perform attestation of the model being utilized. Such attestation is especially important for edge implementations where a large majority of building blocks will be based on AI.

Example attestation approaches disclosed herein utilize a golden set of data to validate a machine learning model (e.g., CNN model) being trained and operated at a remote system (e.g., at an edge device remote from a server). Recognizing that slight variations in models re-trained at such a remote device may be acceptable without indicating a problem, methods and apparatus disclosed herein apply a system of weights to training samples that are adjusted according to a differential comparison of samples ordered by time. By observing anomalistic changes to weighting factors, model training that is influenced by attackers will reveal skewing of the trained models over training that is pristine. Comparing the degree of skewing that an attested model has over previously attested models informs the verifier of possible attacks to a peer node/network's AI engine.

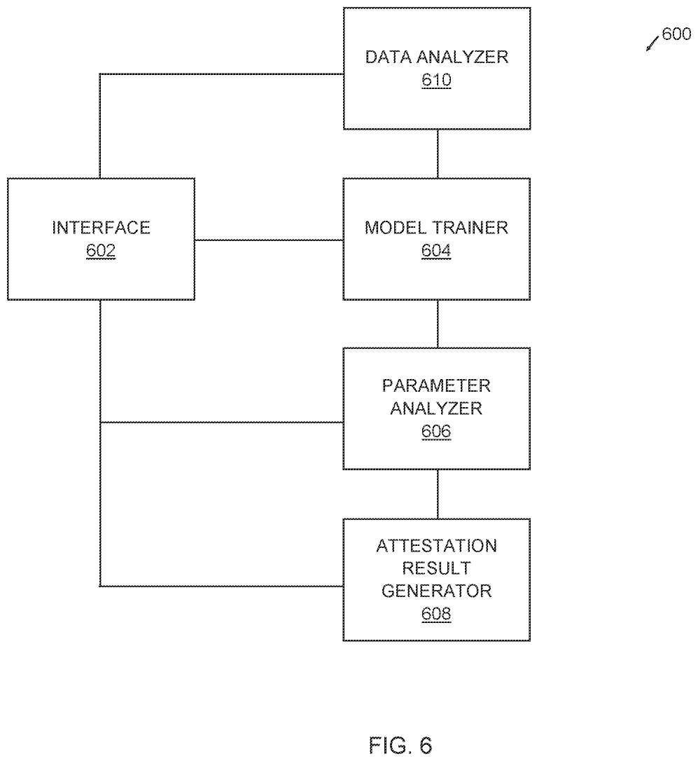

FIG. 6 is a block diagram of an example implementation of an analyzer 600 to perform attestation of a model at a device (e.g., the client compute node 402) that is remote from a server (e.g., a server at the core data center 432).

The example analyzer 600 includes an interface 602 to interface the analyzer 600 with other devices. For example, the interface 602 of the illustrated example, interfaces the analyzer 600 with a network coupled to the internet so that the analyzer 600 may communicate with other local and remote devices (e.g., a server located at the core data center 132).

The example model trainer 604 trains a machine learning model (e.g., a NN, a CNN, etc.). For example, the model trainer 604 may utilize any framework for training machine learning models (e.g., Open Neural Network Exchange, Tensorflow, Keras, Caffe, etc.). The example model trainer 604 may be implemented by a processor executing instructions, an AI hardware accelerator, etc.

The example parameter analyzer 606 collects the results of training by the model trainer 604 and compares the resulting parameters to parameters received from a server that has trained using the same input training samples. For example, the parameter analyzer 606 may apply any type of comparison such as a distance calculation per node, a cost function, etc.

The example attestation result generator 608 analyzes the output of the parameter analyzer 606 to determine an attestation result. According to the illustrated example, the attestation result generator 608 compares an aggregate distance determined by the parameter analyzer 606 to a threshold determination if the attestation passes. Alternatively, the attestation result generator 608 may perform another analysis and may determine any number of possible attestation results. For example, the attestation result generator 608 may utilize machine learning to individually analyze multiple inputs (e.g., individual differences between weights of corresponding nodes) and may be trained on past data to classify a result. A result of the attestation result generator 608 may be a risk percentage, may be a multi-level result (e.g., error, warning, caution). Furthermore, the attestation result generator may identify the individual nodes that indicate a problem (e.g., the nodes where the difference meets a threshold). According to the illustrated example, the attestation result generator 608 transmits a result of the attestation to a server via the interface 602. Alternatively, the attestation result generator 608 may trigger an action based on the result, may report the results to a neighbor device, may retrieve a model from a neighbor device or server, etc.

In some examples, authenticated execution of the CNN may be performed every time a request is sent from the device to the server (e.g., a machine learning as a service (MLaaS) server) supporting the CNN. Typically, for token semantics, a random number is added to the hash of the firmware or other target of attestation claims collection that is generated and signed by the attesting device and subsequently sent to the attestation evidence verification server. Alternatively, the server (as a relying party) can validate the token by communicating with an attestation verification server that knows the golden training data set for the attesting device and can validate the token (e.g., signature of the random number plus firmware). In some examples, the analyzer may utilize a data-centric algorithm to train/match attested or non-attested data sources. The golden training data set may also be known as a standard data set, an attestation data set, a trusted data set, a reference data set, a proprietary data set, a validated data set, a known data set, etc.

While an example manner of implementing the example analyzer 600 is illustrated in FIG. 6, one or more of the elements, processes and/or devices illustrated in FIG. 6 may be combined, divided, re-arranged, omitted, eliminated and/or implemented in any other way. Further, the example interface 602, the example model trainer 604, the example parameter analyzer 606, the example attestation result generator 608, and the example data analyzer 610 and/or, more generally, the example analyzer 600 of FIG. 6 may be implemented by hardware, software, firmware and/or any combination of hardware, software and/or firmware. Thus, for example, any of the example interface 602, the example model trainer 604, the example parameter analyzer 606, the example attestation result generator 608, and the example data analyzer 610 and/or, more generally, the example analyzer 600 of FIG. 6 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example interface 602, the example model trainer 604, the example parameter analyzer 606, the example attestation result generator 608, and the example data analyzer 610 and/or, more generally, the example analyzer 600 of FIG. 6 is/are hereby expressly defined to include a non-transitory computer readable storage device or storage disk such as a memory, a digital versatile disk (DVD), a compact disk (CD), a Blu-ray disk, etc. including the software and/or firmware. Further still, the example analyzer 600 of FIG. 6 may include one or more elements, processes and/or devices in addition to, or instead of, those illustrated in FIG. 6, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

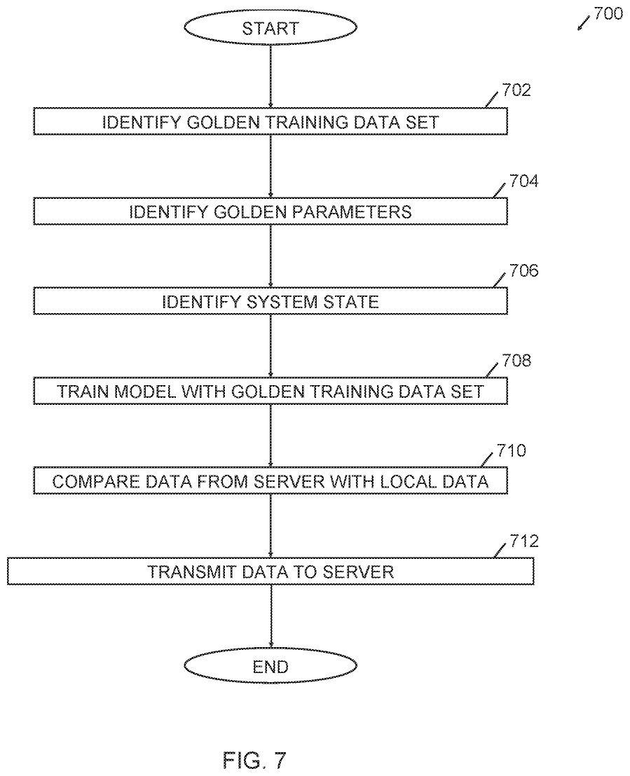

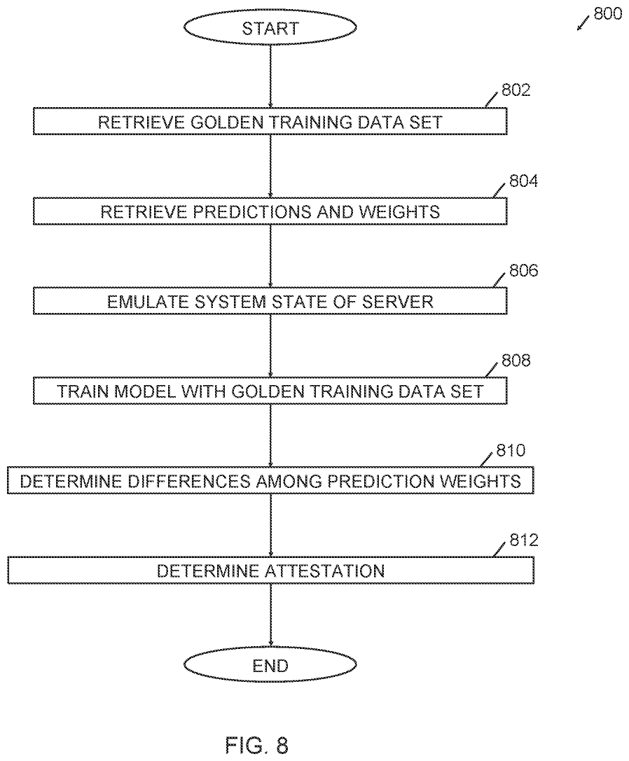

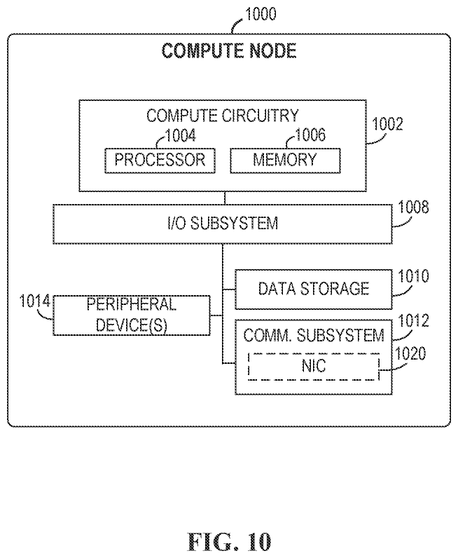

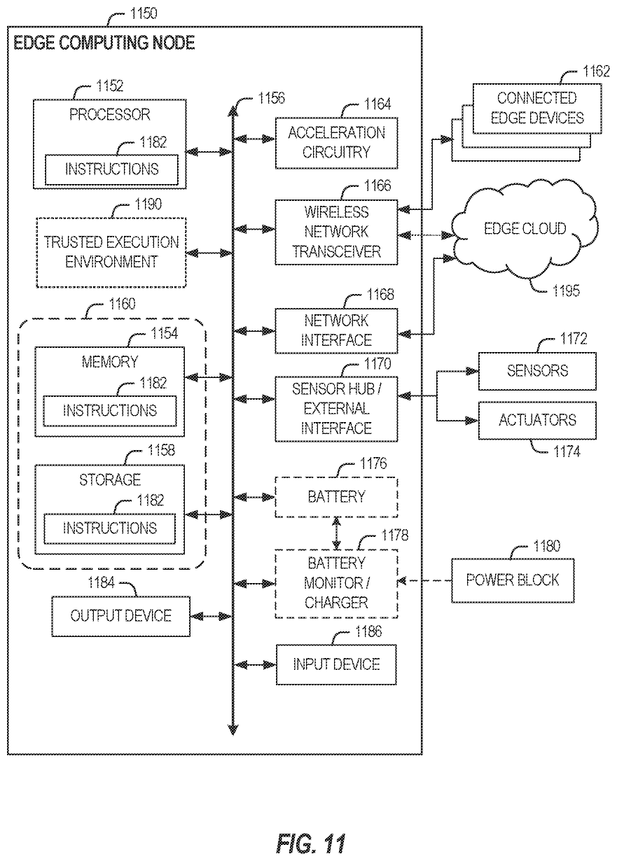

Flowcharts representative of example hardware logic, machine readable instructions, hardware implemented state machines, and/or any combination thereof for implementing the example analyzer 600 of FIG. 6 are shown in FIGS. 7-8. The machine readable instructions may be one or more executable programs or portion(s) of an executable program for execution by a computer processor and/or processor circuitry, such as the processor 1004 shown in the example compute node 1000 discussed below in connection with FIG. 10 and/or the processor 1152 discussed below in connection with FIG. 11. The program may be embodied in software stored on a non-transitory computer readable storage medium such as a CD-ROM, a floppy disk, a hard drive, a DVD, a Blu-ray disk, or a memory associated with the processor 1004 and/or the processor 1152, but the entire program and/or parts thereof could alternatively be executed by a device other than the processor 1004, the processor 1152, and/or embodied in firmware or dedicated hardware. Further, although the example program is described with reference to the flowcharts illustrated in FIGS. 7-8, many other methods of implementing the example analyzer 600 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more devices (e.g., a multi-core processor in a single machine, multiple processors distributed across a server rack, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement one or more functions that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Go, Java, C#, Perl, Python, JavaScript, HyperText Markup Language (HTML), CDDL, JSON, ASN.1, Structured Query Language (SQL), Swift, etc.

As mentioned above, the example processes of FIG. 4 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

FIG. 7 is a flowchart representative of machine readable instructions which may be executed to implement the example analyzer 600 of FIG. 6. An example process 700 illustrated in FIG. 7 may be performed for an offline training phase. The example process 700 of FIG. 7 begins when the example data analyzer 610 identifies a golden training data set (block 702). The golden training data set may be retrieved from a server (e.g., a server in the core data center 432). For example, the golden training data set may be retrieved via the interface 602 at the time of analysis, may be retrieved from a local or remote repository, etc. For example, the golden training data set may be varied over time as the data in the system varies (e.g., due to system software updates, due to changing conditions in a system, etc.). In some examples, the data analyzer 610 may purge all sample data that does not result in more than a threshold variation of the model weights (e.g., more than 8% variation).

During offline analysis, the analyzer 600 may analyze which training samples caused larger changes in weights and which did not change weights. The training samples that did not change weights can be removed from training set data and the training samples that caused a surge in weight change can be analyzed for their validity.

In some examples, the deep learning models are sensitive to the order in which the training data is fed to them. For example, ensuring that good quality data (e.g., high confidence labels) is provided to the training is important. To avoid bias, for example, the training data may be randomly sampled and training may be performed in batches. In addition, the monitoring method along with sample ID may address this bias as well. If a surge in weight was due to good training sample data suddenly coming up, it may be determined that the model may be in error.

The example data analyzer 610 then determines the golden parameters (e.g., the hyperparameters, predictions, etc. at each node of the hidden layers of the model corresponding to the golden training set data applied to a copy of the model at the server) associated with the golden training set (block 704). For example, the golden parameters may be retrieved via the interface 602 from the server and/or may be retrieved from a local or remote repository (e.g., after having been previously received, retrieved, etc. from the server).

The example data analyzer 610 then identifies the system state (e.g., CPU, memory, and/or any other system parameters that may affect the parameters generated during a model training/re-training) (block 706). For example, the data analyzer 610 may retrieve the system state from the server via the interface 602, may retrieve the system state from a local or remote repository, etc.

The example model trainer 604 then trains the local model (e.g., a model currently stored at the client compute node 402) using the golden sample data (block 708). For example, the model trainer 604 may train the data using multiple frameworks (e.g., Open Neural Network Exchange, Tensorflow, Keras, Caffe, etc.) and the parameter analyzer 606 may average the results together to reduce the differences due to different frameworks. According to the illustrated example, the model trainer 604 emulates the system state of the server (e.g., a server located at the core data center 432) from the cloud.

The example attestation result generator 608 then compares the parameters of the server training based on the golden sample data set to measure the differences (block 708). The example attestation result generator 608 then transmits the trained model, the golden training sample data, the golden parameters, and the attestation results to the server (block 710).

Local attestation at a client compute node 402 can be achieved on the edge by downloading (when the client compute node 402 has the connection to the server) from the server and caching the pertinent information (e.g., CNN model, golden training data, golden hyperparameters, golden results). Subsequently the client compute node 402 (e.g., the analyzer 600) can run the training sequence and determine if the CNN model has been tampered with by following the above process flow.

FIG. 8 is a flowchart representative of machine readable instructions which may be executed to implement the example analyzer 600 of FIG. 6. An example process 800 illustrated in FIG. 8 may be performed for a dynamic phase. The example process 800 of FIG. 8 begins when the data analyzer 610 retrieves a golden training set data and the trained model from a server via the interface 602 (block 802). The example data analyzer 610 then retrieves predictions and weights resulting from the training of the golden training set data (block 804).

The example model trainer 604 then emulates the system state (e.g., CPU, memory, etc.) of the server (block 806). The model trainer then performs a training using the golden training set data (block 808). The parameter analyzer 606 then compares the result of the local training with the predictions and weights from the server (block 808). For example, the parameter analyzer 606 may determine an aggregate distance between respective weights of the local training model and the weights of the server trained model.

The example attestation result generator 608 then determines if the comparison from the parameter analyzer indicates that attestation passes or fails (block 810). In some examples, the attestation result generator compares the difference determined by the parameter analyzer 606 to a threshold and indicates that attestation has failed if the difference meets a threshold (e.g., if the difference is greater than a threshold, if the similarly is less than a threshold, etc.). Alternatively, the attestation result generator 608 may determine an indication that is more granular than pass and fail. For example, the attestation result generator 608 may utilize multiple thresholds to determine if an attestation is one of multiple possible results (e.g., green, yellow, red), may output a risk value (e.g., a risk value on a defined scale, a risk percentage value, etc.). Furthermore, the attestation result generator 608 trigger an action based on the result of the attestation (e.g., may trigger a review if the attestation result suggests a problem (e.g., an error, presence of malware, etc.), may send a notification of the result, may trigger the client computing node 402 to be taken offline for correction, etc.). In some examples, the output of the parameter analyzer 606 may be analyzed by the attestation result generator 608 using machine learning. For example, the attestation result generator 608 may utilize a model that has been trained on output of the parameter analyzer 606 operating at multiple devices in a system in order to classify a result as pass/fail or any other types of classifications.

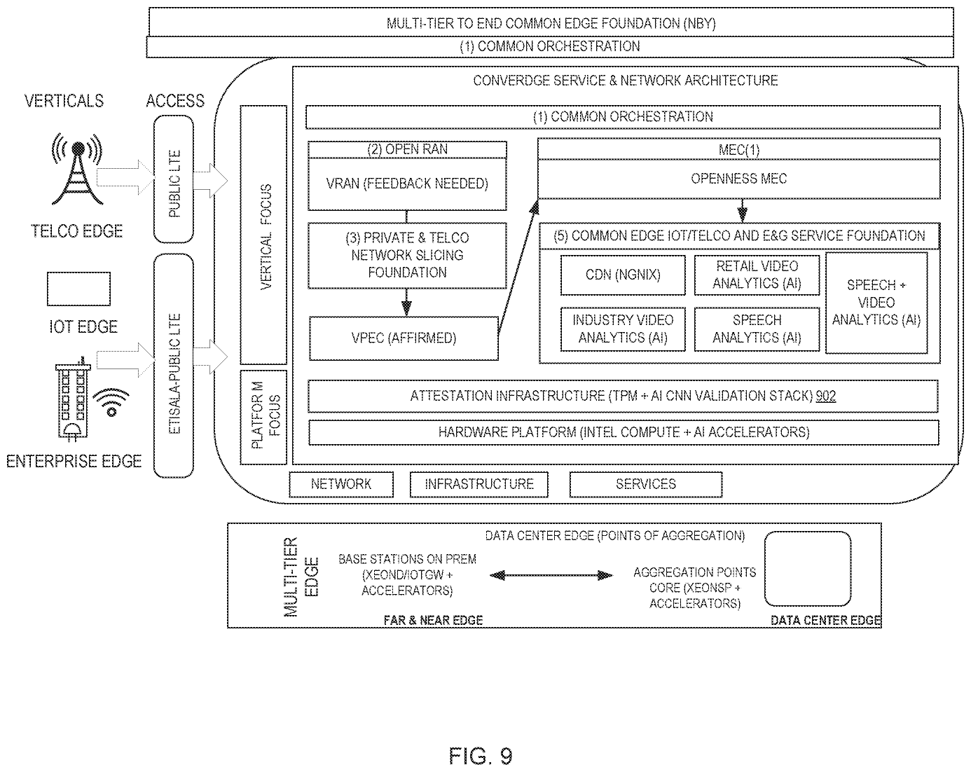

FIG. 9 illustrates an example in which the attestation disclosed herein is deployed in a multi-tiered edge architecture. The system illustrated in FIG. 9 includes an AI CNN validation stack 902 in the attestation infrastructure to track and validate a CNN over time running in both standard compute and accelerators. Such infrastructure allows pseudo-real time (and unsupervised) detection of misbehaviors of CNN deployed in multi-edges. In some examples, the attestation may be performed even in environments that have inconsistent (e.g., not 100%) connectivity to a central server (e.g., IsecL). For example, attestation may be performed while the device performing the attestation is offline by storing attestation information received from a server (e.g., received while the device is online) in memory of the device. Such offline attestation is especially advantageous for large scale edge deployments with thousands of small nodes where connectivity may vary over time.

Any of the compute nodes or devices discussed with reference to the present edge computing systems and environment may be fulfilled based on the components depicted in FIGS. 10 and 11. Respective edge compute nodes may be embodied as a type of device, appliance, computer, or other “thing” capable of communicating with other edge, networking, or endpoint components. For example, an edge compute device may be embodied as a personal computer, server, smartphone, a mobile compute device, a smart appliance, an in-vehicle compute system (e.g., a navigation system), a self-contained device having an outer case, shell, etc., or other device or system capable of performing the described functions.

In the simplified example depicted in FIG. 10, an edge compute node 1000 includes a compute engine (also referred to herein as “compute circuitry”) 1002, an input/output (I/O) subsystem 1008, data storage 1010, a communication circuitry subsystem 1012, and, optionally, one or more peripheral devices 1014. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component.

The compute node 1000 may be embodied as any type of engine, device, or collection of devices capable of performing various compute functions. In some examples, the compute node 1000 may be embodied as a single device such as an integrated circuit, an embedded system, a field-programmable gate array (FPGA), a system-on-a-chip (SOC), or other integrated system or device. In the illustrative example, the compute node 1000 includes or is embodied as a processor 1004 and a memory 1006. The processor 1004 may be embodied as any type of processor capable of performing the functions described herein (e.g., executing an application). For example, the processor 1004 may be embodied as a multi-core processor(s), a microcontroller, a processing unit, a specialized or special purpose processing unit, or other processor or processing/controlling circuit.

In some examples, the processor 1004 may be embodied as, include, or be coupled to an FPGA, an application specific integrated circuit (ASIC), reconfigurable hardware or hardware circuitry, or other specialized hardware to facilitate performance of the functions described herein. Also in some examples, the processor 704 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), acceleration circuitry, storage devices, or AI hardware (e.g., GPUs or programmed FPGAs). Such an xPU may be designed to receive programming to process one or more data streams and perform specific tasks and actions for the data streams (such as hosting microservices, performing service management or orchestration, organizing or managing server or data center hardware, managing service meshes, or collecting and distributing telemetry), outside of the CPU or general purpose processing hardware. However, it will be understood that a xPU, a SOC, a CPU, and other variations of the processor 1004 may work in coordination with each other to execute many types of operations and instructions within and on behalf of the compute node 1000.

The memory 1006 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In an example, the memory device is a block addressable memory device, such as those based on NAND or NOR technologies. A memory device may also include a three-dimensional (3D) crosspoint memory device (e.g., Intel® 3D XPoint™ memory), or other byte addressable write-in-place nonvolatile memory devices. The memory device may refer to the die itself and/or to a packaged memory product. In some examples, 3D crosspoint memory (e.g., Intel® 3D XPoint™ memory) may comprise a transistor-less stackable cross point architecture in which memory cells sit at the intersection of word lines and bit lines and are individually addressable and in which bit storage is based on a change in bulk resistance. In some examples, all or a portion of the memory 1006 may be integrated into the processor 1004. The memory 1006 may store various software and data used during operation such as one or more applications, data operated on by the application(s), libraries, and drivers.

The compute circuitry 1002 is communicatively coupled to other components of the compute node 1000 via the I/O subsystem 1008, which may be embodied as circuitry and/or components to facilitate input/output operations with the compute circuitry 1002 (e.g., with the processor 1004 and/or the main memory 1006) and other components of the compute circuitry 1002. For example, the I/O subsystem 1008 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 1008 may form a portion of a system-on-a-chip (SoC) and be incorporated, along with one or more of the processor 1004, the memory 1006, and other components of the compute circuitry 1002, into the compute circuitry 1002.

The one or more illustrative data storage devices 1010 may be embodied as any type of devices configured for short-term or long-term storage of data such as, for example, memory devices and circuits, memory cards, hard disk drives, solid-state drives, or other data storage devices. Individual data storage devices 1010 may include a system partition that stores data and firmware code for the data storage device 1010. Individual data storage devices 1010 may also include one or more operating system partitions that store data files and executables for operating systems depending on, for example, the type of compute node 1000.

The communication circuitry 1012 may be embodied as any communication circuit, device, or collection thereof, capable of enabling communications over a network between the compute circuitry 1002 and another compute device (e.g., an edge gateway of an implementing edge computing system). The communication circuitry 1012 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, a IoT protocol such as IEEE 802.15.4 or ZigBee®, low-power wide-area network (LPWAN) or low-power wide-area (LPWA) protocols, etc.) to effect such communication.

The illustrative communication circuitry 1012 includes a network interface controller (NIC) 1020, which may also be referred to as a host fabric interface (HFI). The NIC 1020 may be embodied as one or more add-in-boards, daughter cards, network interface cards, controller chips, chipsets, or other devices that may be used by the compute node 1000 to connect with another compute device (e.g., an edge gateway node). In some examples, the NIC 1020 may be embodied as part of a system-on-a-chip (SoC) that includes one or more processors, or included on a multichip package that also contains one or more processors. In some examples, the NIC 1020 may include a local processor (not shown) and/or a local memory (not shown) that are both local to the NIC 1020. In such examples, the local processor of the NIC 1020 may be capable of performing one or more of the functions of the compute circuitry 1002 described herein. Additionally, or alternatively, in such examples, the local memory of the NIC 1020 may be integrated into one or more components of the client compute node at the board level, socket level, chip level, and/or other levels.

Additionally, in some examples, a respective compute node 1000 may include one or more peripheral devices 1014. Such peripheral devices 1014 may include any type of peripheral device found in a compute device or server such as audio input devices, a display, other input/output devices, interface devices, and/or other peripheral devices, depending on the particular type of the compute node 1000. In further examples, the compute node 1000 may be embodied by a respective edge compute node (whether a client, gateway, or aggregation node) in an edge computing system or like forms of appliances, computers, subsystems, circuitry, or other components.

In a more detailed example, FIG. 11 illustrates a block diagram of an example of components that may be present in an edge computing node 1150 for implementing the techniques (e.g., operations, processes, methods, and methodologies) described herein. This edge computing node 1150 provides a closer view of the respective components of node 1000 when implemented as or as part of a computing device (e.g., as a mobile device, a base station, server, gateway, etc.). The edge computing node 1150 may include any combinations of the hardware or logical components referenced herein, and it may include or couple with any device usable with an edge communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the edge computing node 1150, or as components otherwise incorporated within a chassis of a larger system.

The edge computing device 1150 may include processing circuitry in the form of a processor 1152, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 1152 may be a part of a system on a chip (SoC) in which the processor 1152 and other components are formed into a single integrated circuit, or a single package, such as the Edison™ or Galileo™ SoC boards from Intel Corporation, Santa Clara, Calif. As an example, the processor 1152 may include an Intel® Architecture Core™ based CPU processor, such as a Quark™, an Atom™, an i3, an i5, an i7, an i9, or an MCU-class processor, or another such processor available from Intel®. However, any number other processors may be used, such as available from Advanced Micro Devices, Inc. (AMD®) of Sunnyvale, Calif., a MIPS®-based design from MIPS Technologies, Inc. of Sunnyvale, California, an ARM®-based design licensed from ARM Holdings, Ltd. or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc. The processor 1152 and accompanying circuitry may be provided in a single socket form factor, multiple socket form factor, or a variety of other formats, including in limited hardware configurations or configurations that include fewer than all elements shown in FIG. 11.

The processor 1152 may communicate with a system memory 1154 over an interconnect 1156 (e.g., a bus). Any number of memory devices may be used to provide for a given amount of system memory. As examples, the memory 754 may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DEVIMs) of different varieties including but not limited to microDEVIMs or MiniDEVIMs.

To provide for persistent storage of information such as data, applications, operating systems and so forth, a storage 1158 may also couple to the processor 1152 via the interconnect 1156. In an example, the storage 1158 may be implemented via a solid-state disk drive (SSDD). Other devices that may be used for the storage 1158 include flash memory cards, such as Secure Digital (SD) cards, microSD cards, eXtreme Digital (XD) picture cards, and the like, and Universal Serial Bus (USB) flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low power implementations, the storage 1158 may be on-die memory or registers associated with the processor 1152. However, in some examples, the storage 1158 may be implemented using a micro hard disk drive (HDD). Further, any number of new technologies may be used for the storage 1158 in addition to, or instead of, the technologies described, such resistance change memories, phase change memories, holographic memories, or chemical memories, among others.

The components may communicate over the interconnect 1156. The interconnect 1156 may include any number of technologies, including industry standard architecture (ISA), extended ISA (EISA), peripheral component interconnect (PCI), peripheral component interconnect extended (PCIx), PCI express (PCIe), or any number of other technologies. The interconnect 1156 may be a proprietary bus, for example, used in an SoC based system. Other bus systems may be included, such as an Inter-Integrated Circuit (I2C) interface, a Serial Peripheral Interface (SPI) interface, point to point interfaces, and a power bus, among others.

The interconnect 1156 may couple the processor 1152 to a transceiver 1166, for communications with the connected edge devices 1162. The transceiver 1166 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 1162. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 1166 (or multiple transceivers) may communicate using multiple standards or radios for communications at a different range. For example, the edge computing node 1150 may communicate with close devices, e.g., within about 11 meters, using a local transceiver based on Bluetooth Low Energy (BLE), or another low power radio, to save power. More distant connected edge devices 1162, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee®.

A wireless network transceiver 1166 (e.g., a radio transceiver) may be included to communicate with devices or services in a cloud (e.g., an edge cloud 1195) via local or wide area network protocols. The wireless network transceiver 1166 may be a low-power wide-area (LPWA) transceiver that follows the IEEE 802.15.4, or IEEE 802.15.4g standards, among others. The edge computing node 1150 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 1166, as described herein. For example, the transceiver 1166 may include a cellular transceiver that uses spread spectrum (SPA/SAS) communications for implementing high-speed communications. Further, any number of other protocols may be used, such as Wi-Fi® networks for medium speed communications and provision of network communications. The transceiver 1166 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 1168 may be included to provide a wired communication to nodes of the edge cloud 1195 or to other devices, such as the connected edge devices 1162 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 1168 may be included to enable connecting to a second network, for example, a first NIC 1168 providing communications to the cloud over Ethernet, and a second NIC 1168 providing communications to other devices over another type of network.

Given the variety of types of applicable communications from the device to another component or network, applicable communications circuitry used by the device may include or be embodied by any one or more of components 1164, 1166, 1168, or 1170. Accordingly, in various examples, applicable means for communicating (e.g., receiving, transmitting, etc.) may be embodied by such communications circuitry.

The edge computing node 1150 may include or be coupled to acceleration circuitry 1164, which may be embodied by one or more artificial intelligence (AI) accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. These tasks also may include the specific edge computing tasks for service management and service operations discussed elsewhere in this document.

The interconnect 1156 may couple the processor 1152 to a sensor hub or external interface 1170 that is used to connect additional devices or subsystems. The devices may include sensors 1172, such as accelerometers, level sensors, flow sensors, optical light sensors, camera sensors, temperature sensors, global navigation system (e.g., GPS) sensors, pressure sensors, barometric pressure sensors, and the like. The hub or interface 1170 further may be used to connect the edge computing node 1150 to actuators 1174, such as power switches, valve actuators, an audible sound generator, a visual warning device, and the like.

In some optional examples, various input/output (I/O) devices may be present within or connected to, the edge computing node 1150. For example, a display or other output device 1184 may be included to show information, such as sensor readings or actuator position. An input device 1186, such as a touch screen or keypad may be included to accept input. An output device 1184 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the edge computing node 1150. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 1176 may power the edge computing node 1150, although, in examples in which the edge computing node 1150 is mounted in a fixed location, it may have a power supply coupled to an electrical grid, or the battery may be used as a backup or for temporary capabilities. The battery 1176 may be a lithium ion battery, or a metal-air battery, such as a zinc-air battery, an aluminum-air battery, a lithium-air battery, and the like.

A battery monitor/charger 1178 may be included in the edge computing node 1150 to track the state of charge (SoCh) of the battery 1176, if included. The battery monitor/charger 1178 may be used to monitor other parameters of the battery 1176 to provide failure predictions, such as the state of health (SoH) and the state of function (SoF) of the battery 1176. The battery monitor/charger 1178 may include a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, Tex. The battery monitor/charger 1178 may communicate the information on the battery 1176 to the processor 1152 over the interconnect 1156. The battery monitor/charger 1178 may also include an analog-to-digital (ADC) converter that enables the processor 1152 to directly monitor the voltage of the battery 1176 or the current flow from the battery 1176. The battery parameters may be used to determine actions that the edge computing node 1150 may perform, such as transmission frequency, mesh network operation, sensing frequency, and the like.

A power block 1180, or other power supply coupled to a grid, may be coupled with the battery monitor/charger 1178 to charge the battery 1176. In some examples, the power block 1180 may be replaced with a wireless power receiver to obtain the power wirelessly, for example, through a loop antenna in the edge computing node 1150. A wireless battery charging circuit, such as an LTC4020 chip from Linear Technologies of Milpitas, Calif., among others, may be included in the battery monitor/charger 1178. The specific charging circuits may be selected based on the size of the battery 1176, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 1158 may include instructions 1182 in the form of software, firmware, or hardware commands to implement the techniques described herein. Although such instructions 1182 are shown as code blocks included in the memory 1154 and the storage 1158, it may be understood that any of the code blocks may be replaced with hardwired circuits, for example, built into an application specific integrated circuit (ASIC).

In an example, the instructions 1182 provided via the memory 1154, the storage 1158, or the processor 1152 may be embodied as a non-transitory, machine-readable medium 1160 including code to direct the processor 1152 to perform electronic operations in the edge computing node 1150. The processor 1152 may access the non-transitory, machine-readable medium 1160 over the interconnect 1156. For instance, the non-transitory, machine-readable medium 1160 may be embodied by devices described for the storage 1158 or may include specific storage units such as optical disks, flash drives, or any number of other hardware devices. The non-transitory, machine-readable medium 1160 may include instructions to direct the processor 1152 to perform a specific sequence or flow of actions, for example, as described with respect to the flowchart(s) and block diagram(s) of operations and functionality depicted above. As used herein, the terms “machine-readable medium” and “computer-readable medium” are interchangeable.

Also in a specific example, the instructions 1182 on the processor 1152 (separately, or in combination with the instructions 1182 of the machine readable medium 1160) may configure execution or operation of a trusted execution environment (TEE) 1190. In an example, the TEE 1190 operates as a protected area accessible to the processor 1152 for secure execution of instructions and secure access to data. Various implementations of the TEE 1190, and an accompanying secure area in the processor 1152 or the memory 1154 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 1150 through the TEE 1190 and the processor 1152.

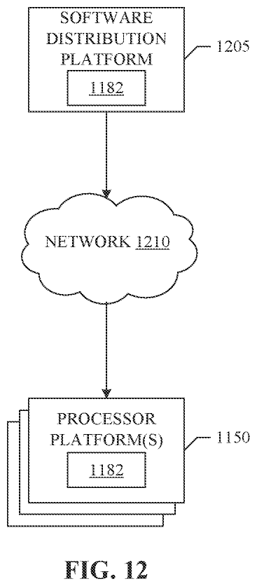

A block diagram illustrating an example software distribution platform 1205 to distribute software such as the example computer readable instructions 1182 of FIG. 11 to third parties is illustrated in FIG. 12. The example software distribution platform 1205 may be implemented by any computer server, data facility, cloud service, etc., capable of storing and transmitting software to other computing devices. The third parties may be customers of the entity owning and/or operating the software distribution platform. For example, the entity that owns and/or operates the software distribution platform may be a developer, a seller, and/or a licensor of software such as the example computer readable instructions 1182 of FIG. 11. The third parties may be consumers, users, retailers, OEMs, etc., who purchase and/or license the software for use and/or re-sale and/or sub-licensing. In the illustrated example, the software distribution platform 1205 includes one or more servers and one or more storage devices. The storage devices store the computer readable instructions 1182, which may correspond to the example computer readable instructions 700 of FIG. 7 and/or 800 of FIG. 8, as described above. The one or more servers of the example software distribution platform 1205 are in communication with a network 1210, which may correspond to any one or more of the Internet and/or any of the example networks described above.

In some examples, the one or more servers are responsive to requests to transmit the software to a requesting party as part of a commercial transaction. Payment for the delivery, sale and/or license of the software may be handled by the one or more servers of the software distribution platform and/or via a third party payment entity. The servers enable purchasers and/or licensors to download the computer readable instructions 1182 from the software distribution platform 1205. For example, the software, which may correspond to the example computer readable instructions 700 of FIG. 7 and/or 800 of FIG. 8, may be downloaded to the example processor platform 1100, which is to execute the computer readable instructions 1182 to implement the example analyzer 600 of FIG. 6. In some example, one or more servers of the software distribution platform 1205 periodically offer, transmit, and/or force updates to the software (e.g., the example computer readable instructions 1182 of FIG. 11) to ensure improvements, patches, updates, etc. are distributed and applied to the software at the end user devices.

From the foregoing, it will be appreciated that example methods, apparatus and articles of manufacture have been disclosed that enable attestation information to be integrated into machine learning models. This has the resultant effect of enabling the machine learning model to generate an output based on the attestation data. As a result, changes in sensors and their corresponding attestation data can be accounted for in the machine learning model. The disclosed methods, apparatus and articles of manufacture improve the efficiency of using a computing device by including attestation data in the metrics used by a machine learning model. The disclosed methods, apparatus and articles of manufacture are accordingly directed to one or more improvement(s) in the functioning of a computer.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

From the foregoing, it will be appreciated that example methods, apparatus and articles of manufacture have been disclosed that enable attestation of a model that is distributed among devices remote from a server (e.g., a mode trained/re-trained at a client computer node within an edge network system). Methods and apparatus disclosed herein facilitate attestation even when devices are not consistently connected to a network. Furthermore, methods and apparatus disclosed herein facilitate an attestation determination in situations where a model may drift from an initial training and still be valid by enabling the updating a golden training set data throughout the life of a system. The disclosed methods, apparatus and articles of manufacture are accordingly directed to one or more improvement(s) in the functioning of a computer.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

Example methods, apparatus, systems, and articles of manufacture for attestation of a machine learning model are disclosed herein. Further examples and combinations thereof include the following:

Example 1 includes an apparatus for attesting a machine learning model, the apparatus comprising memory, instructions, and at least one processor to execute machine readable instructions to at least train a machine learning model using a golden training data set received from a server to generate golden training results, compare the shared model training results to the golden training results, and determine if attestation of the shared model training results passes based on the comparison of the shared model training results and the golden training results.

Example 2 includes the apparatus of example 1, wherein the processor is to execute the instructions to determine if the attestation passes based on a difference between weights of the training and weights of the training results.

Example 3 includes the apparatus of any one of examples 1-2, wherein the at least one processor is to execute the machine readable instructions to emulate a system state of the server during the training by the model trainer.

Example 4 includes the apparatus any one of examples 1-3, wherein the attestation is performed in a multi-tier edge architecture.

Example 5 includes the apparatus of any one of examples 1-4, wherein the apparatus is an edge compute node.

Example 6 includes the apparatus of any one of examples 1-5, wherein the at least one processor is to execute the machine readable instructions to download the machine learning model from the server while connected to a network, download the training samples from the server while connected to the network, and perform attestation while disconnected from the network.

Example 7 includes the apparatus of any one of examples 1-6, wherein the at least one processor is to execute the machine readable instructions to discard the machine learning model if the attestation does not pass.

Example 8 includes an apparatus for attesting a machine learning model, the apparatus comprising a model trainer to train a machine learning model using a golden training data set received from a server to generate golden training results, and an attestation result generator to compare the shared model training results to the golden training results, and determine if attestation of the shared model training results passes based on the comparison of the shared model training results and the golden training results.

Example 9 includes the apparatus of example 8, wherein attestation result generator is to determine if the attestation passes based on a difference between weights of the training and weights of the training results.

Example 10 includes the apparatus of any one of examples 8-9, wherein the model trainer is to emulate a system state of the server during the training by the model trainer.

Example 11 includes the apparatus any one of examples 8-10, wherein the attestation is performed in a multi-tier edge architecture.

Example 12 includes the apparatus of any one of examples 8-11, wherein the apparatus is an edge compute node.

Example 13 includes the apparatus of any one of examples 8-12, further including an interface to download the machine learning model from the server while connected to a network, and download the training samples from the server while connected to the network, wherein the attestation result generator is to perform attestation while disconnected from the network.

Example 14 includes the apparatus of any one of examples 8-13, wherein the attestation result generator is to discard the machine learning model if the attestation does not pass.

Example 15 includes a non-transitory computer readable medium comprising instructions that, when executed machine a machine to at least train a machine learning model using a golden training data set received from a server to generate golden training results, compare the shared model training results to the golden training results, and determine if attestation of the shared model training results passes based on the comparison of the shared model training results and the golden training results.

Example 16 includes the non-transitory computer readable medium of example 15, wherein the instructions, when executed, cause the machine to determine if the attestation passes based on a difference between weights of the training and weights of the training results.

Example 17 includes the non-transitory computer readable medium of any one of examples 15-16, wherein the instructions, when executed, cause the machine to emulate a system state of the server during the training by the model trainer.

Example 18 includes the non-transitory computer readable medium any one of examples 15-17, wherein the attestation is performed in a multi-tier edge architecture.

Example 19 includes the non-transitory computer readable medium of any one of examples 15-18, wherein the machine is an edge compute node.

Example 20 includes the non-transitory computer readable medium of any one of examples 15-19, wherein the instructions, when executed, cause the machine to download the machine learning model from the server while connected to a network, download the training samples from the server while connected to the network, and perform attestation while disconnected from the network.

Example 21 includes the non-transitory computer readable medium of any one of examples 15-20, wherein the instructions, when executed, cause the machine to discard the machine learning model if the attestation does not pass.

Example 22 includes a method for attesting a machine learning model, the method comprising training a machine learning model using a golden training data set received from a server to generate golden training results, comparing the shared model training results to the golden training results, and determining if attestation of the shared model training results passes based on the comparison of the shared model training results and the golden training results.

Example 23 includes the method of example 22, further comprising determining if the attestation passes based on a difference between weights of the training and weights of the training results.

Example 24 includes the method of any one of examples 22-23, further including emulating a system state of the server during the training by the model trainer.

Example 25 includes the method of any one of examples 22-24, wherein the attestation is performed in a multi-tier edge architecture.

Example 26 includes the method of any one of examples 22-25, further including downloading the machine learning model from the server while connected to a network, downloading the training samples from the server while connected to the network, and performing attestation while disconnected from the network.

Example 27 includes the method of any one of examples 22-26, further comprising discarding the machine learning model if the attestation does not pass.

Example 28 includes an apparatus for attesting a machine learning model, the apparatus comprising means for training a machine learning model using a golden training data set received from a server to generate golden training results, and means for comparing the shared model training results to the golden training results, and means for determining if attestation of the shared model training results passes based on the comparison of the shared model training results and the golden training results.

Example 29 includes the apparatus of example 28, wherein the means for determining is to determine if the attestation passes based on a difference between weights of the training and weights of the training results.

Example 30 includes the apparatus of any one of examples 28-29, wherein the means for training is to emulate a system state of the server during the training by the model trainer.

Example 31 includes the apparatus any one of examples 28-30, wherein the attestation is performed in a multi-tier edge architecture.

Example 32 includes the apparatus of any one of examples 28-31, wherein the apparatus is an edge compute node.

Example 33 includes the apparatus of any one of examples 28-32, further including means for downloading to download the machine learning model from the server while connected to a network, and download the training samples from the server while connected to the network, wherein the attestation result generator is to perform attestation while disconnected from the network.

Example 34 includes the apparatus of any one of examples 28-33, wherein the means for determining is to discard the machine learning model if the attestation does not pass.

Example 35 includes an edge computing appliance device operating as a self-contained processing system, the edge computing appliance device comprising: a housing, case, or shell, network communication circuitry, storage memory circuitry, and processor circuitry adapted to perform any of the methods of example 22-27.

Example 36 includes an apparatus of an edge computing system comprising means to perform any of the methods of examples 22-27.

Example 37 is at least one machine-readable medium including instructions that, when executed by processing circuitry, cause the processing circuitry to perform operations to implement any of Examples 1-36.

Example 38 is an apparatus comprising means to implement any of Examples 1-36.

Example 39 is a system to implement any of Examples 1-36.

Example 40 is a method to implement any of Examples 1-36.

Example 41 is a multi-tier edge computing system, comprising a plurality of edge computing nodes provided among on-premise edge, network access edge, or near edge computing settings, the plurality of edge computing nodes configured to perform any of the methods of Examples

Example 42 is an edge computing system, comprising a plurality of edge computing nodes, each of the plurality of edge computing nodes configured to perform any of the methods of Examples 1-36.

Example 43 is an edge computing node, operable as a server hosting the service and a plurality of additional services in an edge computing system, configured to perform any of the methods of Examples 1-36.

Example 44 is an edge computing node, operable in a layer of an edge computing network as an aggregation node, network hub node, gateway node, or core data processing node, configured to perform any of the methods of Examples 1-36.

Example 45 is an edge provisioning, orchestration, or management node, operable in an edge computing system, configured to implement any of the methods of Examples 1-36.

Example 46 is an edge computing network, comprising networking and processing components configured to provide or operate a communications network, to enable an edge computing system to implement any of the methods of Examples 1-36.

Example 47 is an access point, comprising networking and processing components configured to provide or operate a communications network, to enable an edge computing system to implement any of the methods of Examples 1-36.

Example 48 is a base station, comprising networking and processing components configured to provide or operate a communications network, configured as an edge computing system to implement any of the methods of Examples 1-36.

Example 49 is a road-side unit, comprising networking components configured to provide or operate a communications network, configured as an edge computing system to implement any of the methods of Examples 1-36.

Example 50 is an on-premise server, operable in a private communications network distinct from a public edge computing network, configured as an edge computing system to implement any of the methods of Examples 1-36.

Example 51 is a 3GPP 4G/LTE mobile wireless communications system, comprising networking and processing components configured as an edge computing system to implement any of the methods of Examples 1-36.

Example 52 is a 5G network mobile wireless communications system, comprising networking and processing components configured as an edge computing system to implement any of the methods of Examples 1-36.

Example 53 is an edge computing system configured as an edge mesh, provided with a microservice cluster, a microservice cluster with sidecars, or linked microservice clusters with sidecars, configured to implement any of the methods of Examples 1-36.

Example 54 is an edge computing system, comprising circuitry configured to implement services with one or more isolation environments provided among dedicated hardware, virtual machines, containers, or virtual machines on containers, the edge computing system configured to implement any of the methods of Examples 1-36.

Example 55 is an edge computing system, comprising networking and processing components to communicate with a user equipment device, client computing device, provisioning device, or management device to implement any of the methods of Examples 1-36.

Example 56 is networking hardware with network functions implemented thereupon, operable within an edge computing system, the network functions configured to implement any of the methods of Examples 1-36.

Example 57 is acceleration hardware with acceleration functions implemented thereupon, operable in an edge computing system, the acceleration functions configured to implement any of the methods of

Example 58 is storage hardware with storage capabilities implemented thereupon, operable in an edge computing system, the storage hardware configured to implement any of the methods of Examples 1-36.

Example 59 is computation hardware with compute capabilities implemented thereupon, operable in an edge computing system, the computation hardware configured to implement any of the methods of Examples 1-36.

Example 60 is an edge computing system configured to implement services with any of the methods of Examples 1-36, with the services relating to one or more of: compute offload, data caching, video processing, network function virtualization, radio access network management, augmented reality, virtual reality, autonomous driving, vehicle assistance, vehicle communications, industrial automation, retail services, manufacturing operations, smart buildings, energy management, internet of things operations, object detection, speech recognition, healthcare applications, gaming applications, or accelerated content processing.

Example 61 is an apparatus of an edge computing system comprising: one or more processors and one or more computer-readable media comprising instructions that, when executed by the one or more processors, cause the one or more processors to perform any of the methods of Examples 1-36.

Example 62 is one or more computer-readable storage media comprising instructions to cause an electronic device of an edge computing system, upon execution of the instructions by one or more processors of the electronic device, to perform any of the methods of Examples 1-36.

Example 63 is a computer program used in an edge computing system, the computer program comprising instructions, wherein execution of the program by a processing element in the edge computing system is to cause the processing element to perform any of the methods of

Example 64 is an edge computing appliance device operating as a self-contained processing system, comprising a housing, case, or shell, network communication circuitry, storage memory circuitry, and processor circuitry adapted to perform any of the methods of Examples 1-36.

Example 65 is an apparatus of an edge computing system comprising means to perform any of the methods of Examples 1-36.

Example 66 is an apparatus of an edge computing system comprising logic, modules, or circuitry to perform any of the methods of Examples 1-36.

Example 67 is an edge computing system, including respective edge processing devices and nodes to invoke or perform any of the operations of Examples 1-36, or other subject matter described herein.

Example 68 is a client endpoint node, operable to invoke or perform the operations of any of Examples 1-36, or other subject matter described herein.

Example 69 is an aggregation node, network hub node, gateway node, or core data processing node, within or coupled to an edge computing system, operable to invoke or perform the operations of any of Examples 1-36, or other subject matter described herein.

Example 70 is an access point, base station, road-side unit, street-side unit, or on-premise unit, within or coupled to an edge computing system, operable to invoke or perform the operations of any of Examples 1-36, or other subject matter described herein.

Example 71 is an edge provisioning node, service orchestration node, application orchestration node, or multi-tenant management node, within or coupled to an edge computing system, operable to invoke or perform the operations of any of Examples 1-36, or other subject matter described herein.

Example 72 is an edge node operating an edge provisioning service, application or service orchestration service, virtual machine deployment, container deployment, function deployment, and compute management, within or coupled to an edge computing system, operable to invoke or perform the operations of any of Examples 1-36, or other subject matter described herein.

Example 73 is an edge computing system including aspects of network functions, acceleration functions, acceleration hardware, storage hardware, or computation hardware resources, operable to invoke or perform the use cases discussed herein, with use of any Examples 1-36, or other subject matter described herein.

Example 74 is an edge computing system adapted for supporting client mobility, vehicle-to-vehicle (V2V), vehicle-to-everything (V2X), or vehicle-to-infrastructure (V2I) scenarios, and optionally operating according to European Telecommunications Standards Institute (ETSI) Multi-Access Edge Computing (MEC) specifications, operable to invoke or perform the use cases discussed herein, with use of any of Examples 1-36, or other subject matter described herein.

Example 75 is an edge computing system adapted for mobile wireless communications, including configurations according to a 3GPP 4G/LTE or 5G network capabilities, operable to invoke or perform the use cases discussed herein, with use of any of Examples 1-36, or other subject matter described herein.

Example 76 is an edge computing node, operable in a layer of an edge computing network or edge computing system as an aggregation node, network hub node, gateway node, or core data processing node, operable in a close edge, local edge, enterprise edge, on-premise edge, near edge, middle, edge, or far edge network layer, or operable in a set of nodes having common latency, timing, or distance characteristics, operable to invoke or perform the use cases discussed herein, with use of any of Examples 1-36, or other subject matter described herein.

Example 77 is networking hardware, acceleration hardware, storage hardware, or computation hardware, with capabilities implemented thereupon, operable in an edge computing system to invoke or perform the use cases discussed herein, with use of any of Examples 1-36, or other subject matter described herein.

Example 78 is an apparatus of an edge computing system comprising: one or more processors and one or more computer-readable media comprising instructions that, when deployed and executed by the one or more processors, cause the one or more processors to invoke or perform the use cases discussed herein, with use of any of Examples 1-36, or other subject matter described herein.

Example 79 is one or more computer-readable storage media comprising instructions to cause an electronic device of an edge computing system, upon execution of the instructions by one or more processors of the electronic device, to invoke or perform the use cases discussed herein, with use of any of Examples 1-36, or other subject matter described herein.

Example 80 is an apparatus of an edge computing system comprising means, logic, modules, or circuitry to invoke or perform the use cases discussed herein, with the use of any of Examples 1-36, or other subject matter described herein.

The following claims are hereby incorporated into this Detailed Description by this reference, with each claim standing on its own as a separate embodiment of the present disclosure.

1. An apparatus for attesting a machine learning model, the apparatus comprising:
memory;
instructions; and
at least one processor to execute machine readable instructions to at least:
train a machine learning model using a golden training data set received from a server to generate golden training results;
obtain shared model training results;
compare the shared model training results to the golden training; and
determine if attestation of the shared model training results passes based on the comparison of the shared model training results and the golden training results.

2. The apparatus of claim 1, wherein the processor is to execute the instructions to determine if the attestation passes based on a difference between weights of the training and weights of the training results.

3. The apparatus of claim 1, wherein the at least one processor is to execute the machine readable instructions to emulate a system state of the server during the training by the model trainer.

4. The apparatus of claim 1, wherein the attestation is performed in a multi-tier edge architecture.

5. The apparatus of claim 1, wherein the apparatus is an edge compute node.

6. The apparatus of claim 1, wherein the at least one processor is to execute the machine readable instructions to:
download the machine learning model from the server while connected to a network;
download the training samples from the server while connected to the network; and
perform attestation while disconnected from the network.

7. The apparatus of claim 1, wherein the at least one processor is to execute the machine readable instructions to discard the machine learning model if the attestation does not pass.

8. An apparatus for attesting a machine learning model, the apparatus comprising:
a model trainer to train a machine learning model using a golden training data set received from a server to generate golden training results; and
an attestation result generator to:
compare the shared model training results to the golden training results; and
determine if attestation of the shared model training results passes based on the comparison of the shared model training results and the golden training results.

9. The apparatus of claim 8, wherein attestation result generator is to determine if the attestation passes based on a difference between weights of the training and weights of the training results.

10. The apparatus of claim 8, wherein the model trainer is to emulate a system state of the server during the training by the model trainer.

11. The apparatus any one of claims 8-10, wherein the attestation is performed in a multi-tier edge architecture.

12. The apparatus of claim 8, wherein the apparatus is an edge compute node.

13. The apparatus of claim 8, further including an interface to:
download the machine learning model from the server while connected to a network; and
download the training samples from the server while connected to the network, wherein the attestation result generator is to perform attestation while disconnected from the network.

14. The apparatus of claim 8, wherein the attestation result generator is to discard the machine learning model if the attestation does not pass.

15. A non-transitory computer readable medium comprising instructions that, when executed machine a machine to at least:
train a machine learning model using a golden training data set received from a server to generate golden training results;
compare the shared model training results to the golden training results; and
determine if attestation of the shared model training results passes based on the comparison of the shared model training results and the golden training results.

16. The non-transitory computer readable medium of claim 15, wherein the instructions, when executed, cause the machine to determine if the attestation passes based on a difference between weights of the training and weights of the training results.

17. The non-transitory computer readable medium of claim 15, wherein the instructions, when executed, cause the machine to emulate a system state of the server during the training by the model trainer.

18. The non-transitory computer readable medium of claim 15, wherein the attestation is performed in a multi-tier edge architecture.

19. The non-transitory computer readable medium of claim 15, wherein the machine is an edge compute node.

20. The non-transitory computer readable medium of claim 15, wherein the instructions, when executed, cause the machine to:
download the machine learning model from the server while connected to a network;
download the training samples from the server while connected to the network; and
perform attestation while disconnected from the network.

21. The non-transitory computer readable medium of claim 15, wherein the instructions, when executed, cause the machine to discard the machine learning model if the attestation does not pass.

22. A method for attesting a machine learning model, the method comprising:
training a machine learning model using a golden training data set received from a server to generate golden training results;
comparing the shared model training results to the golden training results; and
determining if attestation of the shared model training results passes based on the comparison of the shared model training results and the golden training results.

23. The method of claim 22, further comprising determining if the attestation passes based on a difference between weights of the training and weights of the training results.

24. The method of claim 22, further including emulating a system state of the server during the training by the model trainer.

25. The method of claim 22, wherein the attestation is performed in a multi-tier edge architecture.

26-36. (canceled)
